(19) United States
(12) Patent Application Publication
(10) Pub. No.: US 2006/0284905 A1
(43) Pub. Date: Dec. 21, 2006

(54) Dual mode printer output spectrophotometer and input document scanning system

(75) Inventor: Stan A. Spencer, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/158,149

(22) Filed: Jun. 21, 2005

(51) Int. Cl. B41J 3/00

(52) U.S. Cl. 347/2

(57) ABSTRACT

A color printing system of integrated plural printers with an interconnecting internal sheet path system in which a color imaging bar is positioned to receive, via an alternative internal sheet path, original documents to be electronically imaged from an external sheet feeder in one mode, and to also function in a separate mode as a color spectrophotometer to insure color printing consistency between the respective sheets printed by different color print engines by those sheets being fed to the same color imaging bar location from the various color print engines. That internal imaging bar location may be in or associated with a sheet inverter chute in which the sheets are paused.

Cross-referenced and incorporated by reference [NOT PRIORITY CLAIMED] is a copending TIPP U.S. application Ser. No. 10/761,522 filed Jan. 21, 2004 by Barry Mandel, Robert Lofthus, Steven Moore, Martin Krucinski and Lisbeth Quesnel, entitled “High Print Rate Merging and Finishing. System for Parallel Printing,” projected to be published Jul. 31, 2005 as U.S.PTO Publication No. ______ (Attorney Docket No. A2423-US-NP). Likewise, cross-referenced and incorporated by reference is an allowed divisional application thereof, TIPP U.S. application Ser. No. 11/002,528 filed Dec. 2, 2004 (Attorney Docket No. A2423-US-DIV1), which should issue in approximately the same general time frame.

Also cross-referenced and incorporated by reference [NOT PRIORITY CLAIMED] is copending TIPP U.S. application Ser. No. 11/089,854 filed Mar. 25, 2005, entitled “Sheet Registration Within a Media Inverter” (Attorney Docket No. 20040241-US-NP).

Disclosed in the embodiments herein, in an integrated printing system of combined plural print engines, is an in-line image sensor array, bar or scanner (these terms are used interchangeably herein) capable of electronically capturing the image of an original document, which scanner is appropriately positioned in the internal paper path of the printing system to function as a color spectrophotometer (herein broadly a color printing quality sensor) to insure color printing consistency between the respective color printed sheets outputs of the respective different print engines, such as by closed loop color printing quality control of the respective print engines. Here, the same in-line image sensor bar is alternatively usable in a second and different mode of operation and function by being positioned and provided with an insert or bypass path from an external original documents feeding tray or the like such that alternatively original documents can be fed to this same image sensor array to be digitally image scanned to generate electronic documents, which may be printed. That is, this image sensor array is imbedded in the integrated printing system in a position, and with paper paths, appropriate for both printed copies output quality scanning and input original documents image scanning with the same image sensor array.

Of particular background art interest here is Xerox Corp. U.S. Pat. No. 5,884,118 issued Mar. 16, 1999 to Lingappa K. Mestha, et al, entitled “Printer Having Print Output Linked To Scanner Input For Automated Image Quality Adjustment.” Also of background interest is Xerox Corp. U.S. Pat. No. 5,496,019 issued Mar. 5, 1996 to John R. Yonovich entitled “Dual Function Sheet Feeder,” with two sheet feeding paths from the same external input tray, one to an external imaging station for original documents and another to feed print media sheets to the print engine for printing.

The disclosed embodiment shows a tightly integrated plural printers or print engines “TIPP” system. Thus, noted for background and incorporation by reference (as appropriate) (in addition to the above co-pending TIPP U.S. patent application Ser. No. 10/761,522 and the others cross-referenced there), as to various plural print engine printing systems are some examples of what have been variously called “tandem engine” printers, “cluster printing,” “output merger” systems, etc. For example, Xerox Corp. U.S. Pat. No. 5,568,246 issued Oct. 22, 1996 by Paul D. Keller, et al; U.S. Pat. No. 6,608,988 B2 issued Aug. 19, 2003 by Brian Conrow entitled “Constant Inverter Speed Timing Method and Apparatus for Duplex Sheets in a Tandem Printer;” Canon Corp. U.S. Pat. No. 4,587,532; T/R Systems U.S. Pat. No. 5,596,416 by Barry et al; Canon Corp. U.S. Pat. No. 4,579,446 by Fujimoto; and Fuji Xerox U.S. Pat. No. 5,208,640. Although a TIPP color printing system is described in the example below, it will be appreciated that such color printing systems may also include one or more black and white (black only) printers integrated into the printing system, and the below claims are intended to cover those systems as well.

Also, the disclosed embodiment may utilize existing low cost mass-produced commercially available imaging bars. That is, full document width color imaging (image sensor) bars such as those used in document scanners and/or discussed in the below incorporated cited patents and elsewhere. Their operation or circuitry need not be re-described herein. For example, U.S. Pat. Nos. 5,859,421; 6,166,832; and 6,181,442. Also noted merely by way of further background are Xerox Corp. U.S. Pat. No. 5,808,297 issued Sep. 15, 1998; U.S. Pat. No. 5,543,838 issued Aug. 6, 1996; U.S. Pat. No. 5,550,653 issued Aug. 27, 1996; U.S. Pat. No. 5,604,362 issued Feb. 18, 1997; and U.S. Pat. No. 5,519,514 issued May 21, 1996.

One example of the use of such a full width imaging bar for color spectrophotometer applications for image quality control is Xerox Corp. U.S. Pat. No. 6,621,576 B2 issued Sep. 16, 2003 to Jagdish C. Tandon and Lingappa K. Mestha, entitled “Color Imager Bar Based Spectrophotometer For Color Printer Color Control System.”

A specific feature of the specific embodiment disclosed herein is to provide an integrated color printing system of combined plural color print engines for printing color printed sheets with an interconnecting internal sheet path system wherein said color printed sheets from respective said print engines may be selectively redirected between said print engines, wherein said color printing system also has an automatic external sheet feeder input for the feeding original document sheets to be imaged, wherein a color imaging bar capable of electronically capturing the image of an original document is positioned at a selected internal location in said interconnecting internal sheet path system to function in a first mode as a color spectrophotometer to insure color printing consistency between the respective color printed sheets printed by said plural color print engines, wherein an additional alternative internal sheet path is provided between said automatic external sheet feeder input for original documents to be imaged and said color imaging bar at said selected internal location in said interconnecting internal sheet path system, wherein said color imaging bar is alternatively functional in a second and different mode of operation of electronically capturing the images of said original document sheets fed from said automatic external sheet feeder input through said additional alternative internal sheet path to said color imaging bar at said selected internal location in said interconnecting internal sheet path system.

Further specific features disclosed in the embodiment herein, individually or in combination, include those wherein said color imaging bar provides an in-line full width array color spectrophotometer for said color printed sheets from any of said print engines; and/or wherein said color printing system of combined plural color print engines includes sheet inverters with sheet inversion chutes in said interconnecting internal sheet path system, and wherein said selected internal location in said interconnecting internal sheet path system of said color imaging bar is at one of said sheet inversion chutes; and/or wherein said color printing system of combined plural color print engines includes sheet inverters with sheet inversion chutes in said interconnecting internal sheet path system in which said printed color sheets are stationarily paused, wherein said selected internal location in said interconnecting internal sheet path system of said color imaging bar is at one of said sheet inversion chutes, and wherein said color imaging bar is movable relative to said color sheets stationarily paused in said sheet inversion chutes; and/or a color printing method in which an integrated color printing system of combined plural color print engines prints color printed sheets with an interconnecting internal sheet path system whereby said color printed sheets from respective said print engines are selectively redirectable between said print engines, wherein said color printing system also has an automatic external sheet feeder input for the feeding original document sheets to be imaged, wherein a color imaging bar capable of electronically capturing the image of an original document is positioned at a selected internal location in said interconnecting internal sheet path system, wherein an additional alternative internal sheet path is provided between said automatic external sheet feeder input for original documents to be imaged and said color imaging bar at said selected internal location in said interconnecting internal sheet path system, said color imaging bar functioning in a first mode as a color spectrophotometer to insure color printing consistency between the respective color printed sheets printed by said plural color print engines, said color imaging bar alternatively functioning in a second and different mode of operation of electronically capturing the images of said original document sheets fed from said automatic external sheet feeder input through said additional alternative internal sheet path to said color imaging bar at said selected internal location in said interconnecting internal sheet path system; and/or wherein said color printing system of combined plural color print engines includes sheet inverters with sheet inversion chutes in said interconnecting internal sheet path system in which said printed color sheets are stationarily paused, wherein said selected internal location in said interconnecting internal sheet path system of said color imaging bar is at one of said sheet inversion chutes, and wherein said color imaging bar is movable relative to said color sheets stationarily paused in said sheet inversion chutes.

The disclosed system may be operated and controlled by appropriate operation of conventional control systems. It is well known and preferable to program and execute imaging, printing, paper handling, and other control functions and logic with software instructions for conventional or general purpose microprocessors, as taught by numerous prior patents and commercial products. Such programming or software may, of course, vary depending on the particular functions, software type, and microprocessor or other computer system utilized, but will be available to, or readily programmable without undue experimentation from, functional descriptions, such as those provided herein, and/or prior knowledge of functions which are conventional, together with general knowledge in the software or computer arts. Alternatively, the disclosed control system or method may be implemented partially or fully in hardware, using standard logic circuits or single chip VLSI designs.

The term “reproduction apparatus” or “printer” as used herein broadly encompasses various printers, copiers or multifunction machines or systems, xerographic or otherwise, unless otherwise defined in a claim. The term “sheet” herein refers to a usually flimsy physical sheet of paper, plastic, or other suitable physical substrate for images, whether precut or web fed.

As to specific components of the subject apparatus or methods, or alternatives therefor, it will be appreciated that, as is normally the case, some such components are known per se in other apparatus or applications, which may be additionally or alternatively used herein, including those from art cited herein. For example, it will be appreciated by respective engineers and others that many of the particular component mountings, component actuations, or component drive systems illustrated herein are merely exemplary, and that the same novel motions and functions can be provided by many other known or readily available alternatives. All cited references, and their references, are incorporated by reference herein where appropriate for teachings of additional or alternative details, features, and/or technical background. What is well known to those skilled in the art need not be described herein.

Various of the above-mentioned and further features and advantages will be apparent to those skilled in the art from the specific apparatus and its operation or methods described in the example(s) below, and the claims. Thus, they will be better understood from this description of these specific embodiment(s), including the drawing figures (which are approximately to scale) wherein:

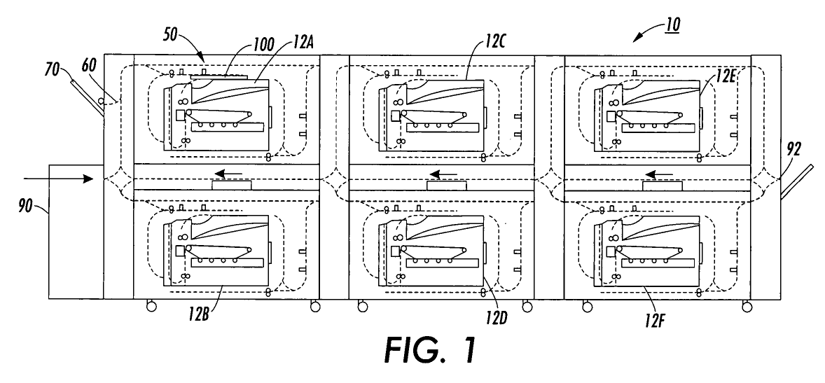

FIG. 1 is a schematic frontal view of a six IOT version of a TIPP system modified as described herein, and

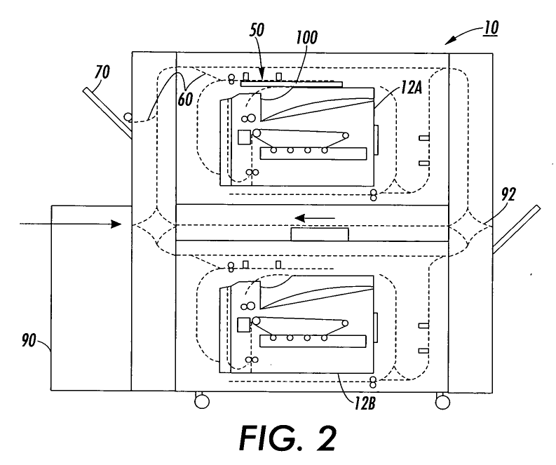

FIG. 2 is a partial, two IOT, version of the FIG. 1 TIPP system modified as described herein.

Describing now in further detail the exemplary embodiments with reference to the Figures, there is shown one example of a TIPP system 10. Such TIPP systems have plural or multiple integrated electronic printers, such as the six print engines 12A through 12F of FIG. 1, or the two print engines 12A and 12B thereof of FIG. 2, (otherwise known as image output terminals or IOTs), each of which can have varying image quality (IQ) performance. The printed output sheets from all or several of these integrated IOTs are typically compiled together into common multi-page documents or booklets via an integrated paper path system as illustrated by the arrows here. This IQ consistency and performance, especially of facing pages within the same printed booklet, can be visually significant to the customer. A presently suggested solution is to have the customer print certain test patterns on sheets printed from all IOTs, then place them in a document handler for scanning, at which point the TIPP system may make automatic xerographic parameter adjustments to align the respective IQ's of the respective IOTs.

In the present embodiment an image sensor array, bar or scanner 100 is mounted inside the machine, preferably directly below a sheets inverter (and optional re-registration) subsystem 50, allowing for a sheet to be scanned there while the sheet is temporarily stopped in the inverter/registration system, or at another such suitable location. The information from this sheet scan may be used to calibrate and modify the respective IOT marking parameters to ensure that the IQ is consistent between IOTs. In a TIPP system as disclosed herein, which has a selective paper path system which allows sheets from almost any area to be sent to almost any other area, only one such image scanner 100 is needed. The scanner 100 can be mounted to move to scan an original document, a test sheet, or a system 10 printed sheet, while that sheet is stationary in the inverter chute of the inverter subsystem 50, or be mounted stationary to scan the sheet as the sheet is moving in or out of the subsystem 50, or other appropriate sheet path position internally of the system 10.

Here, In addition, an external to internal bypass type document transport path 60 to this same image scanner 100 is provided in place of a traditional external document handler, scanner and platen glass (as in the above-cited U.S. Pat. No. 5,884,118 issued to Lingappa K. Mestha, et al) to allow original documents to be fed in from an input tray 70 and scanned by this same scanner 100 (and then sent to an output tray 80 for retrieval).

The exemplary TIPP system 10 here shows such integrated sheet path transports between the exemplary IOTs 12A-12F, which here are modularly stacked in towers of two IOT's each, as in FIG. 2. The print media paper input source 90 and its sheet feeder(s) is shown on the left. The sheet can be sent to any location in the path and returned to any location via plural return highway transports and plural inverters, as shown, before outputting at 92 to a stacking tray system or finisher. These inverter subsystems, such as 50, may contain integral sheet re-registration systems to remove sheet skew or other registration errors.

The disclosed embodiment eliminates any requirement for a customer to have to manually run an IQ calibration routine for the system 10. Any test calibration sheet can be periodically automatically fed from a sheet input tray 70 (instead of a normal document) through the same path 60 to the same inverter subsystem 50 and scanned there by this same scanner 100 to generate quality and/or color consistency test patterns to be printed on copies of that test sheet by all of the IOTs, and those test prints can then be automatically fed to, and compared by, the same scanner 100. This can be done at any time, especially when the system 10 is not in printing use. This can keep the prints much more consistent between IOTs by running the IQ routine on a more regular basis, effectively closing the loop on the IQ process.

Using the feed tray 70, bypass transport path 60, and scanner 100 in combination to image-scan original documents desirably eliminates the need for an external scanner with a document handler and platen glass to provide single system or multi-function document copying capability. Original documents to be copied may be scanned and sent to the output 92 for customer retrieval, while test documents scanned for calibration purposes can be stored in a conventional external or internal purge bin or tray within an IOT, or otherwise, and emptied at a convenient time by the customer. Such as a conventional purge bin or tray used for purging sheets from an incomplete or misprinted print job due to an unexpected shutdown from a sheet jam or otherwise.

Sheet inverters, and their sheet inversion chutes in which sheets are stationarily paused before their movement reversal and exit therefrom, are of course well known to those of ordinary skill in the paper path and sheet handling art of printers and need not be described in detail herein. Particularly noted is the above-cited TIPP U.S. application Ser. No. 11/089,854 filed Mar. 25, 2005 on an integral sheet inverter and sheet deskew and registration system.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. An integrated color printing system of combined plural color print engines for printing color printed sheets with an interconnecting internal sheet path system wherein said color printed sheets from respective said print engines may be selectively redirected between said print engines,
wherein said color printing system also has an automatic external sheet feeder input for the feeding original document sheets to be imaged,
wherein a color imaging bar capable of electronically capturing the image of an original document is positioned at a selected internal location in said interconnecting internal sheet path system to function in a first mode as a color spectrophotometer to insure color printing consistency between the respective color printed sheets printed by said plural color print engines,
wherein an additional alternative internal sheet path is provided between said automatic external sheet feeder input for original documents to be imaged and said color imaging bar at said selected internal location in said interconnecting internal sheet path system,
wherein said color imaging bar is alternatively functional in a second and different mode of operation of electronically capturing the images of said original document sheets fed from said automatic external sheet feeder input through said additional alternative internal sheet path to said color imaging bar at said selected internal location in said interconnecting internal sheet path system.

2. The integrated color printing system of claim 1, wherein said color imaging bar provides an in-line full width array color spectrophotometer for said color printed sheets from any of said print engines.

3. The integrated color printing system of claim 1, wherein said color printing system of combined plural color print engines includes sheet inverters with sheet inversion chutes in said interconnecting internal sheet path system, and
wherein said selected internal location in said interconnecting internal sheet path system of said color imaging bar is at one of said sheet inversion chutes.

4. The integrated color printing system of claim 1, wherein said color printing system of combined plural color print engines includes sheet inverters with sheet inversion chutes in said interconnecting internal sheet path system in which said printed color sheets are stationarily paused,
wherein said selected internal location in said interconnecting internal sheet path system of said color imaging bar is at one of said sheet inversion chutes, and
wherein said color imaging bar is movable relative to said color sheets stationarily paused in said sheet inversion chutes.

5. A color printing method in which an integrated color printing system of combined plural color print engines prints color printed sheets with an interconnecting internal sheet path system whereby said color printed sheets from respective said print engines are selectively redirectable between said print engines,
wherein said color printing system also has an automatic external sheet feeder input for the feeding original document sheets to be imaged,
wherein a color imaging bar capable of electronically capturing the image of an original document is positioned at a selected internal location in said interconnecting internal sheet path system,
wherein an additional alternative internal sheet path is provided between said automatic external sheet feeder input for original documents to be imaged and said color imaging bar at said selected internal location in said interconnecting internal sheet path system,
said color imaging bar functioning in a first mode as a color spectrophotometer to insure color printing consistency between the respective color printed sheets printed by said plural color print engines,
said color imaging bar alternatively functioning in a second and different mode of operation of electronically capturing the images of said original document sheets fed from said automatic external sheet feeder input through said additional alternative internal sheet path to said color imaging bar at said selected internal location in said interconnecting internal sheet path system.

6. The color printing method of claim 5, wherein said color printing system of combined plural color print engines includes sheet inverters with sheet inversion chutes in said interconnecting internal sheet path system in which said printed color sheets are stationarily paused,
wherein said selected internal location in said interconnecting internal sheet path system of said color imaging bar is at one of said sheet inversion chutes, and
wherein said color imaging bar is movable relative to said color sheets stationarily paused in said sheet inversion chutes.
